(19) United States
(12) Patent Application Publication
(10) Pub. No.: US 2015/0007012 A1
(43) Pub. Date: Jan. 1, 2015

(54) SYSTEM AND METHOD FOR USING SHARED HIGHLIGHTING FOR VARIOUS CONTEXTS TO DRIVE A RECOMMENDATION ENGINE

(71) Applicant: International Business Machines Corporation, Armonk, NY (US)

(72) Inventors: Denise A. Bell, Austin, TX (US); Lisa Seacat DeLuca, Baltimore, MD (US); Jana H. Jenkins, Raleigh, NC (US); Jeffrey A. Kusnitz, Campbell, CA (US)

(21) Appl. No.: 13/928,423

(22) Filed: Jun. 27, 2013

(51) Int. Cl. G06F 17/24

(52) U.S. Cl. CPC G06F 17/241
USPC 715/230

(57) ABSTRACT

A method of using shared notations for recommendations in an electronic social forum includes receiving a first item selection from a first user. The first item selection includes a first context, and the first item selection includes a first notation. A second item selection is received from a second user having a second context, and the second item selection also includes a second notation. The method analyzes the first notation and the second notation for an associated notation to the first notation. Further, the method identifies a first recommended item based on the associated notation; and presents the first recommended item to the first user. At least one of the steps can be performed using a program executable by a processor of a computer.

### BACKGROUND

1. Field

The present disclosure relates to a method of using shared notations for initiating recommendations in an electronic social forum.

2. Background of the Disclosure

A shared social forum may include, for example, a retailer's or seller's website, or a website where bids for purchasing an item or service are entered. For example, e-commerce sites accessible through the Internet can offer user product recommendations. These recommendations may typically be based on the similarities of products and/or purchasing habits. For example, if a user purchases a book on a retailer website, the retailer can recommend another book to the user having a similar author, having a similar or the same topic, or being related in some other way. In another example, a user may purchase an accessory to an item, for instance a kitchen appliance. The retailer can recommend the accessory to another user who has purchased the same item. The retailer's website may also provide other users' recommendations and comments on the purchased product or similar products.

### BRIEF SUMMARY OF THE DISCLOSURE

In one instance, there may be a need for a method to analyze user feedback and selections in an electronic forum, such as, purchases on a website that can include notations and highlights provided by a user. In another example, it would be desirable for a method to provide a technique for sharing feedback and selections for generating recommendations in an electronic social forum. Such a technique and method can be referred to as a recommendation engine.

According to an embodiment of the invention, a method of using shared notations for recommendations in an electronic social forum includes, receiving a first item selection from a first user. The first item selection includes a first context, and a first notation. A second item selection is received from a second user having a second context, and the second item selection includes a second notation. The method analyzes the first notation and the second notation for an associated notation to the first notation; identifies a first recommended item based on the associated notation; and presents the first recommended item to the first user. At least one of the above steps is performed using a program executable by a processor of a computer.

In another embodiment of the invention, a computer program product uses shared notations for recommendations in an electronic social forum. The computer program product comprises a computer readable storage medium having program code embodied therewith, and the program code is readable/executable by a processor to perform a method, comprising: receiving a first item selection from a first user, the first item selection including a first context and a first notation; receiving a second item selection from a second user having a second context, the second item selection including a second notation; analyzing the first notation and the second notation for an associated notation to the first notation; identifying a first recommended item based on the associated notation; and presenting the first recommended item to the first user, wherein at least one of the above steps is performed using a service including a program executable by a processor of a computer.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is a schematic block diagram illustrating an overview of the system and methodology for using shared notations for recommendations in an electronic social forum, according to an embodiment of the disclosure;

FIG. 2 is a flow chart illustrating a method for using shared notations for recommendations in an electronic social forum according to an embodiment of the disclosure, using the system shown in FIG. 1;

FIG. 3 is a flow chart depicting a method according to another embodiment of the disclosure which continues from the method shown in FIG. 2; and

FIG. 4 is block diagram according to an embodiment of the disclosure depicting modules of the computer program shown FIG. 1.

### DETAILED DESCRIPTION OF THE DISCLOSURE

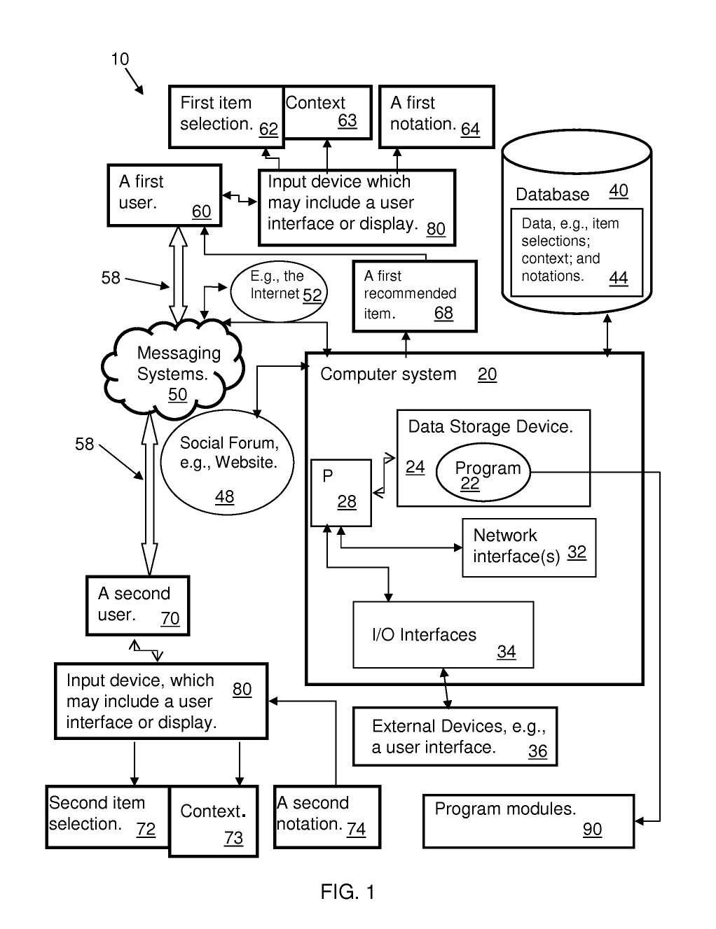

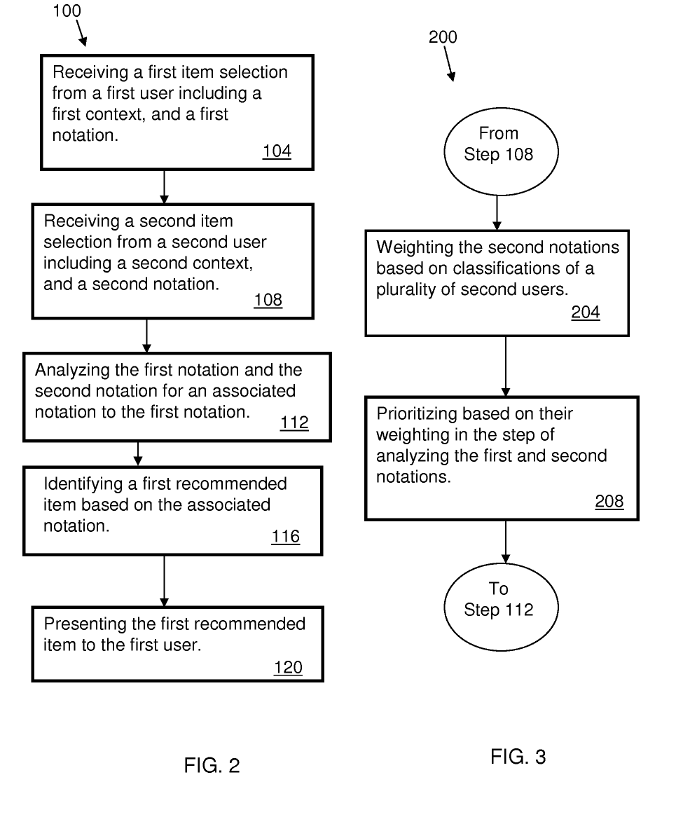

Referring to FIGS. 1 and 2, a system 10 and a method 100 for managing shared selections for recommendations in an electronic social forum, according to an embodiment of the invention are described below. Step 104 of the method 100 includes receiving a first item selection 62 and first context 63 from a first user 60, using an input device 80. The first item selection 62 includes a first notation 64. The first item selection 62 may include a purchased item on a retailer's website. Thus, a social forum may be embodied as an online retail forum, e.g., a website 48 accessible via the Internet, and the first item selection is a retail item. The retailer's website 48 may provide a venue for recommendations, customer reviews, and comments. The website may provide purchase recommendations based on what other customers have bought who have shopped using the website. The context, including the first context or any context of subsequent item selection by one or more users, may include the item's use, category of service or type of item, for example, a home appliance, lawn maintenance items, or books, etc. A notation, including the first notation and any subsequent notations from one or more users, may include input from the user, such as, highlighting, notes, indications, recommendation, etc.

The input device 80 may include a user interface, for example, a display. The first and second users 60, 70 are generic representations of one or more users. Each of the users have access to an input device 80 (also may be referred to as a communication device). The input device 80 is a generic representation of one or more devices which can access a website and may be able to send an electronic message such as a text or email. The access to a website is represented by arrow 58 in FIG. 1, for example, to the Internet 52 to access the website 48 via its computer system 20. The input devices may include, for example, a computer, or Personal Data Assistant (PDA), cell phone, notebook, or the like. Access to a website may be accomplished, for example, using a (PDA) which uses a communications system, e.g., messaging system 50 which can include the Internet 52, or a public switched telephone network (PSTN) for example, a cellular network. The PSTN may include telephone lines, fiber optic cables, microwave transmission links, cellular networks, and communications satellites. The computer system 20 shown in FIG. 1 is a generic computer system which is representative of a server having a database and hosting one or more websites, and also representative of a user computer.

The method 100 may be embodied in a program 22 embodied on a computer readable storage device, e.g., data storage device 24, and which is executable by a processor 28 of the computer 20 (i.e., execute program steps, code, or program code). The program or executable instructions therefrom, may be offered as a service by a provider. The program may be an add-on or sub-program to an existing program, such as an addition to a website shopping recommendations. The program may also be stored and run locally on a user device. The computer 20 and program 22 shown in FIG. 1 are generic representations of a computer and program that may be local to a user, or provided as a remote service, such as a website accessible using the Internet. The computer 20 also generically represents a computer device such as a personal data assistant, a laptop, or desktop computer, etc., or part of one or more servers, alone or as part of a datacenter. The computer system 20 can include a network interface 32, and input/output (I/O) interface(s) 34. The I/O interface 34 allows for input and output of data with an external device 36 that may be connected to the computing device. The network interface 32 may provide communications between the computing device and a computer network.

Referring to step 108 in FIG. 1, the method 100 receives a second item selection 72 and context 73 from a second user 70 having a second notation 74, using an input device 80 as discussed above. Step 112 includes analyzing (which can include comparing) the first notation and the second notation for an associated notation to the first notation. The first and second notations may be compared to determine if the notations are associated. The second item selection may be embodied as a plurality of second item selections from a respective plurality of second users. Each of the plurality of second item selections may include respective second notations. The plurality of second notations from multiple users can be compared to the first notation to determine an association based on commonality, for instance, the same topic, or person, place or thing, etc., to determine and identify an associated notation.

Step 116 includes identifying a first recommended item 68 based on the associated notation. For example, once an associated notation is determined in step 112, the item that the notation was referring to can be identified and constitute the first recommended item. The first recommended item 68 is presented to the first user, in step 120. The first recommended item can be presented to the first user, for example, on a computer while accessing a retailer's website.

Referring to FIG. 3, in another embodiment of the disclosure, the method 100 may further include weighting the second notations based on classifications of a plurality of second users, as in step 204, which follows from step 108 of FIG. 3. The weighted second notations are prioritized in step 208 based on their weighting for use in step 112 of method 100 for analyzing the first and second notations. In one instance, the higher the weighting, the higher the priority of the notation. The classifications for determining the weightings can include: an expert, a teacher, a frequent user, a novice user. The classification identification can be made by self identification. For example, a notation can have a weighting based on its classifications as from an expert user, and the weighting of the expert user notation has a higher weight. Thereby, in step 112 of the method 100, the weighted expert user notation has a higher value than a non expert user notation for analyzing the first and second notations to determine a first recommended item based on the associated notation as in step 116.

By way of example, experts status or another status of a user can be initiated by self identification and can include, personal interests, personal experience, education level; educational and life experience in specific areas or fields.

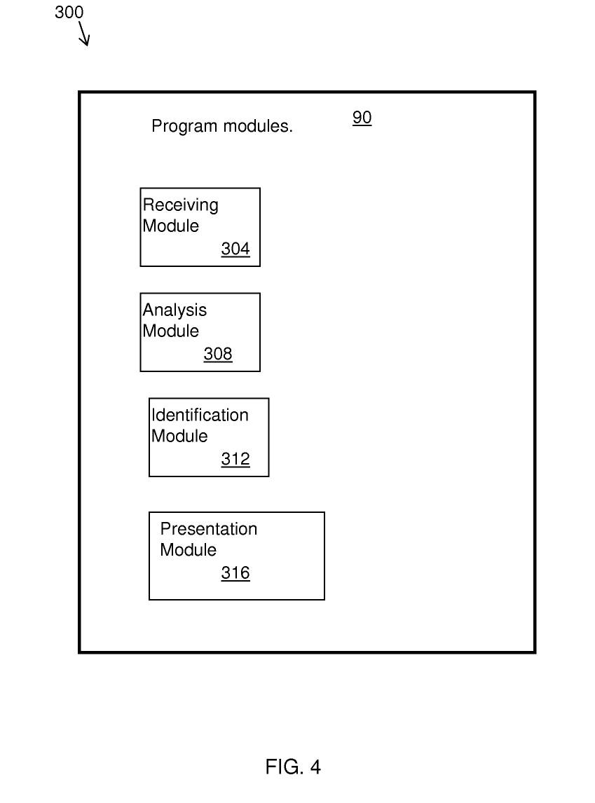

The program 22 may include program modules 90 for executing specific steps, routines, sub-routines, instructions or code, of the program. Such modules 90 are generically represented in FIG. 1 and FIG. 4. By way of example, referring to FIG. 4, block diagram 300 expands on the modules 90 to include a receiving module 304 for receiving the first item selection 62 and the second item selection 72. An analysis module 308 can analyze the first notation and the second notation for an associated notation to the first notation. An identification module 312 can identify the first recommended item based on the associated notation. A presentation module 316 can send or present the first recommended item to the first user.

The plurality of item selections and respective contexts from multiple users, generically represented by second user(s) 70, can be stored in a database 40 as shown in FIG. 1. The data 44 (including item selections, respective contexts, and notations) are accessible for analyzing the first and second notations as in step 112. Analyzing the first and second notations in step 112 may include associating a plurality of item selections and contexts as well as the notations. As discussed above the notations may be weighted. A prioritized list, or ranking, of recommendations may be generated based on the weighted notations and the similarity of selections and contexts.

More specifically, there can be numerous ways and types of notations. The first and second notations may include: highlighting, marking, circling, bolding, italicizing, tagging, an identification of an inconsistency, a styling update, coloring, downloading, rating, commenting, and reviewing. The user may be identified and categorized as an expert, a teacher, a frequent user, a novice user, a reviewer, a notation provider, and a buyer.

As discussed above, the method 100 of the present disclosure can generate recommendations by providing a mechanism or a recommendation engine where shared notations are used to generate relevant recommendations for a user, which are enhanced or improved from recommendation techniques known in the art. The method 100 of the present disclosure provides finer grained recommendations by comparing notations resulting in more relevant recommendations in the context of the item selected by the user. The method's 100 technique weights notations higher which can be considered of higher interest to an end user in the context of the item. This results in a finer granulation of recommendations of enhanced quality and relevance to the first users sectioned item.

By way of example, a plurality of users are generically represented by users 70. Each of the users 70 have access to an input device 80 (which may also be referred to as a communications device). The input device 80 is a generic representation of one or more devices which can access the Internet, access a website, and may also be capable of sending an electronic message such as a text or email. The input device 80 may include, a computer, or Personal Data Assistant (PDA), cell phone, notebook, or the like.

For a plurality of users, the method of the present disclosure can determine and provide recommendations to each user based on other users' selections and notations. In the example shown in FIG. 1, one or more second users' selections and notations can be used generate recommendations to the first user, and the first user's 60 selection and notations can be used to generate one or more recommendations for one or more second users. The recommendations can exclude a selection that the user has already selected.

In another example, first and second item selections can be considered data which may be stored in a database 40 of a computer system 20. The computer system can be part of a website service, for instance a retailers website service, a service for recommendations as provided by the method disclosed herein.

Thereby, according to the present disclosure, the method 100 of using shared notations for recommendations in an electronic social forum includes receiving the first item selection 62 including the first context from the first user 60, as in step 104. The first item selection includes the first notation 64. The method 100 receives the second item selection 72 which includes the second context 73, from the second user, in step 108. The second item selection includes the second notation 74. The first and second notations are analyzed for an associated notation to the first notation. The first recommended item 69 is identified based on the associated notation, as in step 116. The first recommended item is presented to the first user, as in step 120.

While embodiments of the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

Therefore, one or more Figures described herein may illustrate a schematic of an embodiment of the disclosure and may include a representative computer system or processing system that may implement a method and a program in one or more embodiments of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with one or more processing systems in the present disclosure may include, but are not limited to, personal computer systems, server computer systems, handheld or laptop devices, multiprocessor systems, microprocessor-based systems, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units, a system memory, and a bus that couples various system components including system memory to processor. Computer system may include a variety of computer system readable media. Such media may be any available media that is accessible by computer system, and it may include both volatile and non-volatile media, removable and non-removable media. System memory 58, shown in FIG. 1, can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices such as a keyboard, a pointing device, a display, etc.; one or more devices that enable a user to interact with computer system; and/or any devices (e.g., network card, modem, etc.) that enable computer system to communicate with one or more other computing devices. Such communication can occur via Input/Output (I/O) interfaces. Additionally, computer systems can communicate with one or more networks such as a local area network (LAN), a general wide area network (WAN), and/or a public network (e.g., the Internet) via network adapter. As depicted, network adapter communicates with the other components of computer system via bus. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

Additionally, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Further, any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams as may be illustrated in the one or more Figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments, features, and instructive examples described above are illustrative, and should not be construed to limit the present disclosure to the particular embodiments or enumerated examples. Thus, various changes and modifications may be effected by one skilled in the art without departing from the spirit or scope of the disclosure as defined in the appended claims.

What is claimed is:

1. A method of using shared notations for recommendations in an electronic social forum, comprising the steps of:
receiving a first item selection from a first user, the first item selection including a first context and a first notation;
receiving a second item selection from a second user having a second context, the second item selection including a second notation;
analyzing the first notation and the second notation for an associated notation to the first notation;
identifying a first recommended item based on the associated notation; and
presenting the first recommended item to the first user, wherein at least one of the above steps is performed using a program executable by a processor of a computer.

2. The method of claim 1, further comprising:
receiving a plurality of second item selections from a plurality of second users having respective second contexts and respective second notations; and
analyzing the first notation with the second notations for the associated notation.

3. The method of claim 2, further comprising:
weighting the second notations based on classifications of the second users, wherein the weighted second notations are prioritized based on their weighting in the step of analyzing the first and second notations.

4. The method of claim 3, wherein the classifications include: an expert, a teacher, a frequent user, a novice user, a reviewer, a notation provider, and a buyer.

5. The method of claim 3, wherein second users are classified by a self identification by the second users.

6. The method of claim 3, wherein the classifications include an expert user, and the weighting of an expert user notation is of a higher value than a non expert user notation for the step of analyzing the first and second notations.

7. The method of claim 1, wherein a plurality of item selections and respective contexts, and first and second notations from multiple users are stored in a database and accessible for the step of analyzing the first and second notations.

8. The method of claim 1, wherein the step of analyzing the first and second notations includes associating a plurality of selections and contexts, and the first and second notations, and ranking a plurality of recommended items based on the plurality of selections and contexts, and first and second notations.

9. The method of claim 1, wherein the social forum is an online retail forum accessible using the Internet, and the first item selection is a retail item advertised on the online retail forum.

10. The method of claim 1, wherein the first and second notations include: highlighting; marking, circling, bolding, italicizing, tagging, an identification of an inconsistency, a styling update, coloring, downloading, rating, and reviewing.

11. A computer program product for using shared notations for recommendations in an electronic social forum, the computer program product comprising a computer readable storage medium having program code embodied therewith, the program code being readable/executable by a processor to perform a method, comprising:
receiving a first item selection from a first user, the first item selection including a first context and a first notation;
receiving a second item selection from a second user having a second context, the second item selection including a second notation;
analyzing the first notation and the second notation for an associated notation to the first notation;
identifying a first recommended item based on the associated notation; and
presenting the first recommended item to the first user, wherein at least one of the above steps is performed using a service including a program executable by a processor of a computer.

12. The computer program product of claim 11, further comprising:
receiving a plurality of second item selections from a plurality of second users having respective second contexts and respective second notations; and
analyzing the first notation with the second notations for the associated notation.

13. The computer program product of claim 12, further comprising:
weighting the second notations based on classifications of the second users, wherein the weighted second notations are prioritized based on their weighting in the step of analyzing the first and second notations.

14. The computer program product of claim 13, wherein the classifications include: an expert, a teacher, a frequent user, a novice user, a reviewer, a notation provider, and a buyer.

15. The computer program product of claim 13, wherein second users are classified by a self identification by the second users.

16. The computer program product of claim 13, wherein the classifications include an expert user, and the weighting of an expert user notation is of a higher value than a non expert user notation for the step of analyzing the first and second notations.

17. The computer program product of claim 11, wherein a plurality of item selections and respective contexts, and first and second notations from multiple users are stored in a database and accessible for the step of analyzing the first and second notations.

18. The computer program product of claim 11, wherein the step of analyzing the first and second notations includes associating a plurality of selections and contexts, and the first and second notations, and ranking a plurality of recommended items based on the plurality of selections and contexts, and first and second notations.

19. The computer program product of claim 11, wherein the social forum is an online retail forum accessible using the Internet, and the first item selection is a retail item advertised on the online retail forum.

20. The computer program product of claim 11, wherein the first and second notations include: highlighting; marking, circling, bolding, italicizing, tagging, an identification of an inconsistency, a styling update, coloring, downloading, rating, and reviewing.
